(19) United States
(12) Patent Application Publication
(10) Pub. No.: US 2012/0259726 A1
(43) Pub. Date: Oct. 11, 2012

(54) SYSTEM AND METHOD FOR DESIGNING, CREATING AND DISTRIBUTING CONSUMER-SPECIFIED PRODUCTS

(75) Inventors: Joakim Andreasson, New York, NY (US); Robert Cordero, New York, NY (US)

(73) Assignee: BAMIN INC, New York, NY (US)

(21) Appl. No.: 13/081,199

(22) Filed: Apr. 6, 2011

(51) Int. Cl. G06Q 30/00; G06F 15/16

(52) U.S. Cl. 705/26.5; 709/203

(57) ABSTRACT

A system and method for producing custom-designed objects. Design information is input to the system by a designer; an inquiry is input by a customer. Product information is presented to the customer relating to the inquiry; the product represents an embodiment of the design. The design may be iteratively modified in accordance with additional information input by the designer and/or product preferences input by the customer. After the customer places a product order, the product is delivered to the customer; the product may include components assemblable by the customer so that the customer obtains a customized product.

### FIELD OF THE DISCLOSURE

This disclosure relates to designing and ordering consumer goods, and more particularly to a system where both designer and consumer influence the design for greater customer satisfaction.

### BACKGROUND OF THE DISCLOSURE

Online retail offerings and ordering of consumer goods from online catalogs are now well known. Online “stores” generally resemble their traditional counterparts by offering a consumer a limited number of items in a limited range of configurations (e.g. clothing in certain sizes and in a restricted number of colors and/or functions). Customers thus have a limited range of choices in the design, appearance and function of the goods. Customers sometimes prefer that the item they order have, to some degree, a different design from what is offered. In addition, customers are sometimes disappointed to find that their chosen item or color is not available. Furthermore, even when an order is placed at electronic speed, a customer generally must wait for delivery by traditional means (postal service, parcel service, etc.).

It therefore is desirable to implement a system whereby a customer may modify the design of a desired item or create a new item based on available components, and specify its appearance (e.g. color). Furthermore, it is desirable for the system to cause the item to be produced (either complete or assemblable by the customer) in real time at the customer's location, and involve the customer in the creative process.

### SUMMARY OF THE DISCLOSURE

The present disclosure provides a system for designing, creating and distributing customer-specified (and in some instances customer-assembled) products. A customer using a system according to the present disclosure (referred to herein as “BAMIN”) may purchase an item and have it produced and delivered at the customer's location immediately, or for assembly via conventional delivery.

According to a first aspect of the disclosure, a method includes receiving design information input by a designer, and receiving an inquiry input by a customer. Product information is presented to the customer relating to the inquiry, where the product represents an embodiment of the design. The design is then iteratively modified in accordance with additional information input by the designer and/or product preferences input by the customer. After a product order is received from the customer, the product is sent to the customer; alternatively, the product may be produced by a device accessible by the customer. The product also may be delivered in a plurality of components for assembly by the customer.

In an embodiment, the product includes a plurality of components assemblable by the customer, and those components are assemblable into a plurality of configurations. The customer may thus assemble a customized product.

The design information and customer inquiry may be received at a server connected to a network; the design information and additional information may be stored on a storage device connected to the server or the network.

According to another aspect of the disclosure, a computer-readable storage medium has stored therein instructions for performing a method as outlined above.

According to a further aspect of the disclosure, a system includes a server configured to receive design information input by a designer; receive an inquiry input by a customer; and to present product information to the customer relating to the inquiry, the product representing an embodiment of the design. The system is also configured to iteratively modify the design in accordance with additional information input by the designer and/or product preferences input by the customer, and to receive a product order from the customer. Distribution of the product may be by a conventional delivery service, or by a device (e.g. a printer for printing on paper or fabric) at the customer's location configured to produce the product in accordance with instructions from the server. The product may be delivered either complete or in components for assembly by the customer.

More generally, the system may be embodied in software-as-a-service, and the method may be realized as an on-demand application service in an Internet computing (“cloud computing”) environment.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a schematic illustration of a customer and a designer each communicating with the BAMIN system to design an item meeting the customer's preferences.

FIG. 2 is a schematic illustration of an online embodiment of a BAMIN system, where the designer contributes a design, and the customer may modify the design and order a product.

FIG. 3 is a flow chart of a method for designing, modifying, creating and distributing goods in accordance with an embodiment of the disclosure.

FIG. 4 is a schematic illustration in exploded view of a modular zipper bag whose components may be specified and/or modified by a customer, according to an embodiment of the disclosure.

FIGS. 5A and 5B are schematic illustrations in perspective view of the modular zipper bag of FIG. 4, with a round end.

FIGS. 6A and 6B schematically illustrate in perspective view different customer-specified configurations of the modular zipper bag of FIG. 4, with square and oblong ends respectively.

FIG. 7 is a schematic illustration of a customer interacting with a stand-alone BAMIN system, in accordance with another embodiment of the disclosure.

### DETAILED DESCRIPTION

A system and method according to the disclosure is applicable to a variety of items (for example, carrying bags, clothing, and decorative items) offered to a customer via a website, and which may be offered in a variety of colors, materials, sizes and functions.

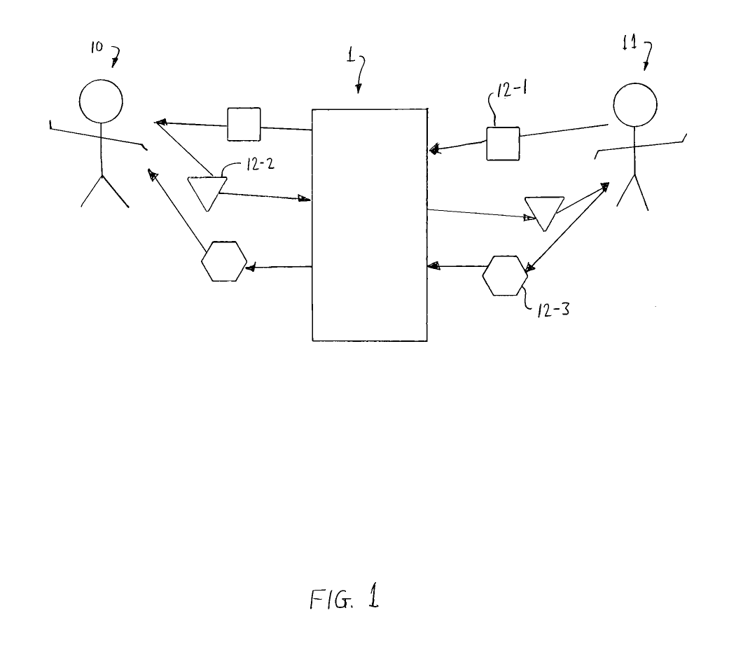

FIG. 1 schematically illustrates the interaction of a customer 10 and a designer 11, respectively, with the BAMIN system 1. Designer 11 creates a design 12-1, and makes it available on system 1. A customer interacting with the system may order goods based on design 12-1, or may modify the design in accordance with his preferences. The modified design 12-2 is re-transmitted to system 1, so that it may be viewed by the designer. The designer may make further modifications to increase customer satisfaction, and make that new design 12-3 available on the system. This process therefore is iterative and moreover may be collaborative; the customer is involved in customizing the goods to a degree not found in conventional online product ordering. It is not necessary for the customer and designer to communicate directly or to interact in real time.

A variety of goods may be designed and produced, including fashion, design, art and decorative products. In cases where the product is designed for immediate delivery, the media in which the goods are produced (e.g. paper, fabric) will depend on the online materials and the resources at the customer's location.

In accordance with the BAMIN system, the customer becomes a co-creator of the product. Although this is generally outside the designer's usual business model, it is nevertheless attractive to the designer because it generates revenue for the designer immediately and engages the designer's audience in the creative process, while ensuring a high level of customer satisfaction.

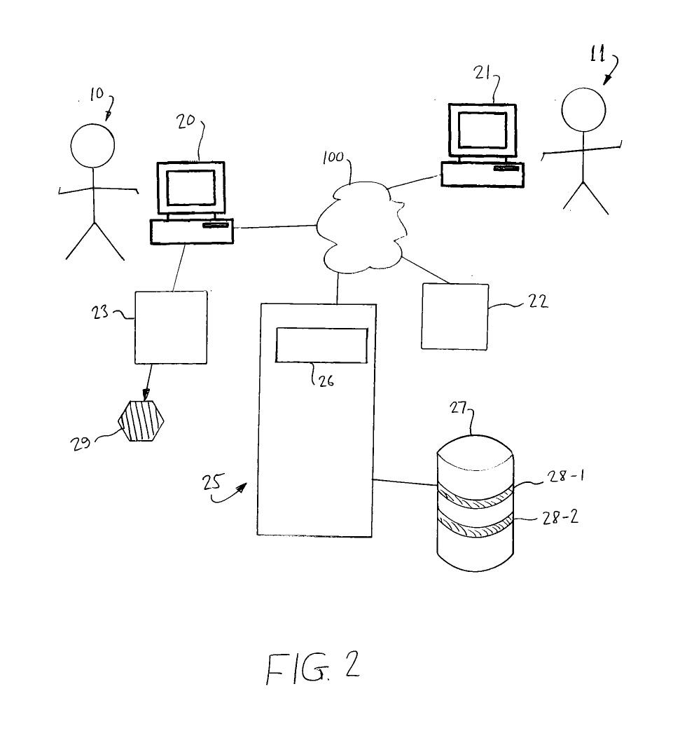

FIG. 2 schematically illustrates an embodiment of a BAMIN system where the BAMIN system functions as an online platform for offering and modifying designs of goods. Customer 10 and designer 11 each communicate with a server 25 over a network 100 (e.g. the Internet), using their respective personal computing devices 20, 21 respectively. Although devices 20, 21 are shown as desktop PCs, it will be appreciated that a variety of computing devices may be used (e.g. mobile digital devices, PDAs, etc.). The BAMIN software 26, according to this embodiment, executes on server 25 and supports a web site (presenting to customer and designer over their devices 20, 21) where designs may be offered by the designer, modified by either the customer or designer, and ordered by the customer.

A new design may be input directly by the designer via his computing device 21, or uploaded to the BAMIN system from a storage device 22. A storage unit 27 stores designs 28-1 as they are originally offered, and the modifications 28-2 made by each customer. Since each customer may make his/her own distinct modifications, each new design from designer 11 may generate a large number of new designs derived from the original. Storage unit 27 may be directly connected to server 25 as shown or be accessed remotely by server 25 via the network 100. The BAMIN software involves both design operations (for example, displays and graphics changing in response to customer and/or designer input) and business operations (for example, order processing). In an embodiment, after a customer's order is processed, the customer downloads the modified design which is executed on a peripheral device 23 at the customer's location. A product 29 (either finished or assemblable) may thus be immediately delivered to the customer. For example, the design may be a fabric design modified by the customer, and device 23 may be a color printer capable of printing fabrics; the desired product 29 is accordingly printed at the customer's location. In another example, the design may comprise the outlines of a plurality of two-dimensional shapes printed on paper at the customer's location, which the customer then cuts out and assembles into a three-dimensional decorative item.

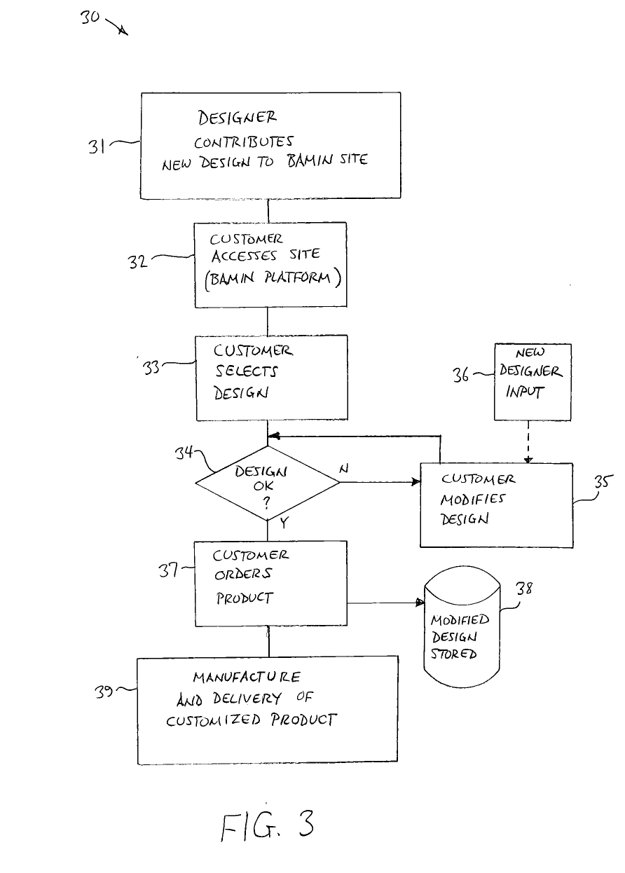

FIG. 3 is a flowchart showing a method 30 embodying the BAMIN system. Designer 11 contributes one or more product designs to be offered by the BAMIN system, e.g. on the BAMIN website (step 31). The customer 10 accesses the site (step 32), and proceeds to browse through the product designs offered. The customer selects a product design (step 33) that meets his preferences to some extent. If the customer is satisfied with the design (step 34), he proceeds to order the product (step 37).

If, in step 34, the customer is not satisfied with the product, the customer is invited to modify the product design (step 35), for example with respect to size, color, decorative or functional details, etc. New input 36 from the designer may further modify and improve the design. This new input may be in addition to, or in response to, modifications contributed by the customer. Accordingly, new design ideas are generated (a plurality of designs derived from the original offering), while a product is created meeting the customer's individual needs.

The customer places an order for a product with the modified design (step 37); the modified design is stored (step 38) in a storage device.

The designed product, or assemblable parts of the product, is then made and delivered to the customer (step 39). In particular embodiments, the design is executed—that is, the product is made and/or assembled—at the customer's location (e.g. home or workplace) in an appropriate medium using equipment readily accessible to the customer (e.g. a fabric or paper printer). The product (or components thereof ready for assembly) is thus immediately delivered to the customer, further enhancing the customer's satisfaction with the design/ordering/purchasing experience. In other embodiments, the BAMIN system causes the product or components to be delivered via a conventional system such as the mail or parcel delivery service. A plurality of components may be delivered to the customer, so that the customer may assemble a customized product from those components.

In an embodiment, the equipment at the customer's location outputs a two-dimensional product; for example, a color printer produces a design on paper or fabric. To give a particular example, a fabric printer may produce an assemblable garment, with the customer being instructed to cut out various pieces and put them together. In another embodiment, the equipment may be a printer/fabricator of three-dimensional objects, for example a computer-controlled injection molding device, producing plastic objects in a variety of colors.

### Example

### Modular Zipper Bag

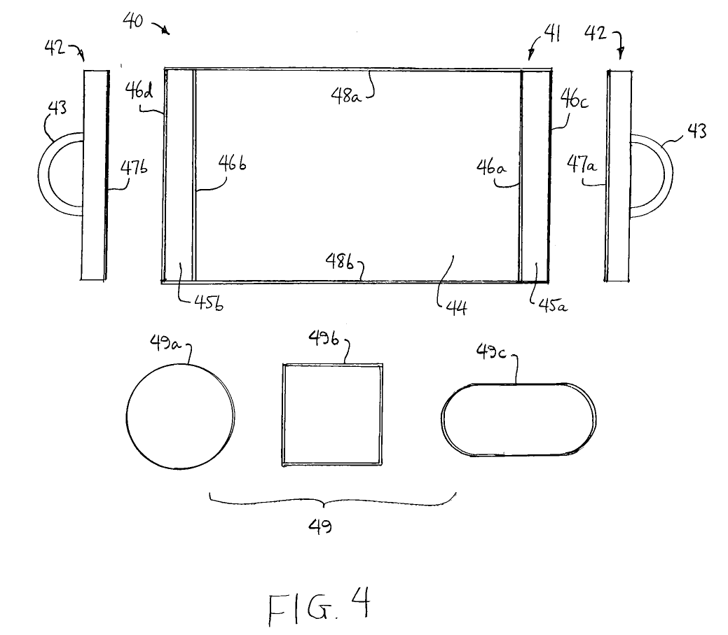

An embodiment of the disclosure will be described with reference to a design for a modular zipper bag 40, components of which are shown in exploded view in FIG. 4. The bag includes a main body 41, two ends 49, and detachable handle pieces 42 with handles 43. Handles 43 may be a variety of lengths, thereby enhancing the functionality of the bag; for example, a short handle as shown in FIG. 4 or a longer handle. A removable shoulder strap (not shown) may also be provided, which may be attached to handle piece 42.

The main body 41 includes three panels 44, 45a, 45b of a flexible material and joined along seams having zippers 46a, 46b sewn thereto. As shown in FIG. 4, portions 45a and 45b also have zippered edges 46c, 46d respectively at the outer ends (short edges) of main body 41. Main body 41 has long zippered edges 48a, 48b. Handle pieces 42 have zippered edges 47a, 47b.

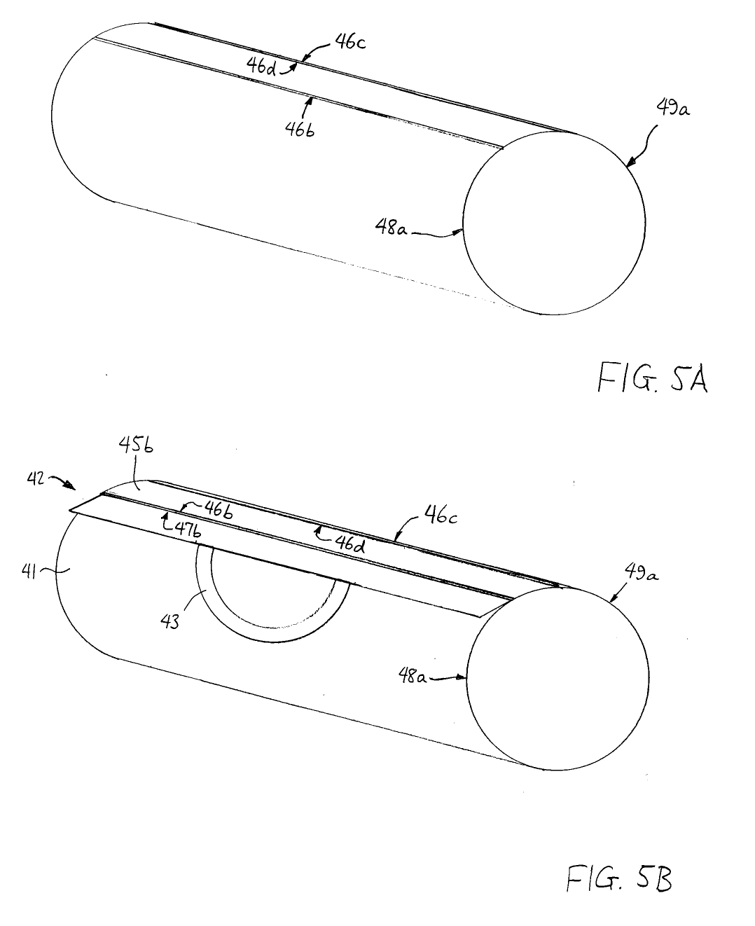

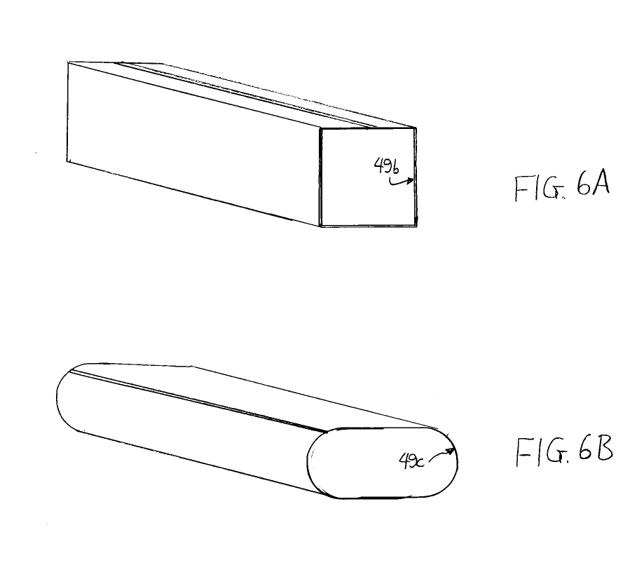

The bag is formed by folding main body 41 into a tube, approximating edge 46c to 46d and zippering those edges together. Edges 48a and 48b are then each joined to an outer zippered edge 49a, 49b or 49c of the desired end piece 49. The resulting tube-shaped, closed bag may thus have a round end (as shown in FIG. 5A), a generally square end (as shown in FIG. 6A), or a generally oblong end (as shown in FIG. 6B). The handle pieces 42 are attached to the bag by zippering together the long edges thereof to edges 46a and 46b of panel 44. In the perspective view of FIG. 5B, one of the handle pieces 42 is visible with handle 43. Edge 47b of the handle piece is joined to the main body by zippering to edge 46b.

It will be appreciated that other end piece shapes may be used in constructing the bag. Additional components (e.g. a pocket which may be attached to the bag) may also be provided.

Referring again to FIG. 3, a customer accessing the BAMIN site (step 32) may select the design for bag 40 and then input his/her specifications for the bag (step 33) in any of a wide variety of configurations. The various pieces of the bag (as shown in FIG. 4) may be offered on the BAMIN website in several different colors; the bag may also be offered in several different lengths (different lengths of outer edges 46c, 46d) and cross-sectional areas (different lengths of edges 48a, 48b, which correspond to the circumference of the end pieces). It will be appreciated that a large number of combinations are possible to meet the customer's needs. Furthermore, in an embodiment, the customer may specify (steps 34, 35) a size or end piece shape not in current inventory, but which may be manufactured to suit the customer (step 39). A new design feature contributed by the customer (e.g. a triangular end piece in addition to the round, square and oblong end pieces of FIG. 4) may be stored as a modified design (step 38). After the components of the bag are manufactured or drawn from inventory in accordance with the customer's order, they are shipped to the customer by a conventional method. The bag 40 is an example of an assemblable product, since the components of the bag are assembled by the customer as desired.

The BAMIN system and method as described above are implemented in a client-server environment, with the designer and customer each communicating with the server via the Internet using their personal computing devices. It will be appreciated that the BAMIN system and method may be provided in a variety of other ways; for example, as an on-demand service in a “cloud computing” environment. The foregoing description is intended to apply to computing devices, software platforms, and web services arrangements available both now and in the future.

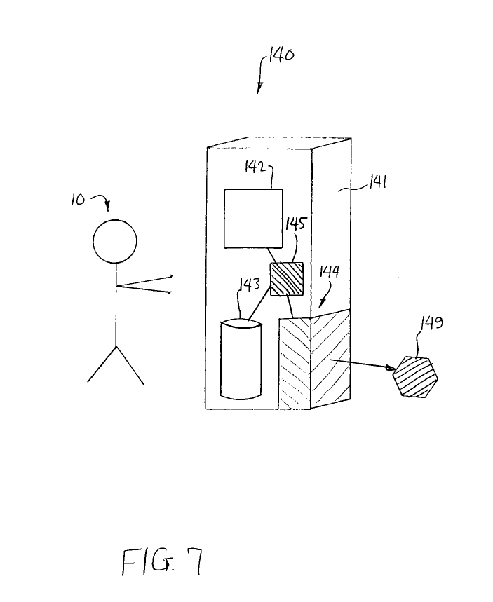

FIG. 7 is a schematic illustration of an alternative implementation of a BAMIN system, according to another embodiment. BAMIN system 140 is implemented at a kiosk 141; customer 10 interacts with the system via an input device, such as a touchscreen 142. A processor 145 is linked to the input device, to a storage device 143, and to an output device (e.g. a printer) 144. Processor 145 retrieves designs offered to the customer from storage 143; the customer may modify a design, purchase a product based on the design, and obtain the manufactured product 149 via the output device. The kiosk 141 may be a stand-alone unit as shown, or may be linked to a remote server and/or storage via a network.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

We claim:

1. A method comprising:
receiving design information input by a designer;
receiving an inquiry input by a customer;
presenting product information to the customer relating to the inquiry, the product representing an embodiment of the design;
iteratively modifying the design in accordance with at least one of
additional information input by the designer and
product preferences input by the customer;
receiving a product order from the customer; and
causing said product to be delivered to the customer.

2. A method according to claim 1, further comprising:
storing at least one of said design information and said additional information on a storage device.

3. A method according to claim 1, wherein said step of receiving design information further comprises receiving design information uploaded via a network.

4. A method according to claim 1, wherein said design information and said inquiry are received at a server connected to a network.

5. A method according to claim 1, wherein said product information includes a plurality of configurations of the product, so that a plurality of options are offered to the customer with regard to the product.

6. A method according to claim 1, further comprising iteratively presenting the modified designs to the customer and/or to the designer, and wherein said presenting is performed via a website.

7. A method according to claim 1, further comprising receiving additional customer product preferences subsequent to said step of presenting product information.

8. A method according to claim 1, wherein said product is delivered as components for assembly at the customer's location.

9. A method according to claim 1, wherein said step of causing said product to be delivered further comprises transmitting instructions to a device accessible to the customer to produce the product.

10. A method according to claim 9, wherein the device is a printer, and said instructions cause the printer to print the design on paper or fabric.

11. A method according to claim 9, wherein the device produces components of the product for assembly at the customer's location.

12. A computer-readable storage medium having stored therein instructions for performing a method, the method comprising the steps of:
receiving design information input by a designer;
receiving an inquiry input by a customer;
presenting product information to the customer relating to the inquiry, the product representing an embodiment of the design;
iteratively modifying the design in accordance with at least one of
additional information input by the designer and
product preferences input by the customer;
receiving a product order from the customer; and
causing said product to be delivered to the customer.

13. A computer-readable storage medium according to claim 12, wherein said design information and said inquiry are received at a server connected to a network.

14. A computer-readable storage medium according to claim 12, wherein said product information includes a plurality of configurations of the product, so that a plurality of options are offered to the customer with regard to the product.

15. A computer-readable storage medium according to claim 12, further comprising iteratively presenting the modified designs to the customer and/or to the designer, and wherein said presenting is performed via a website.

16. A computer-readable storage medium according to claim 12, wherein said product is delivered as components for assembly at the customer's location.

17. A computer-readable storage medium according to claim 12, wherein said step of causing said product to be delivered further comprises transmitting instructions to a device accessible to the customer to produce the product.

18. A computer-readable storage medium according to claim 17, wherein the device is a printer, and said instructions cause the printer to print a design on paper or fabric.

19. A method according to claim 17, wherein the device produces components of the product for assembly at the customer's location.

20. A computer-readable storage medium according to claim 12, wherein the storage medium is configured as part of a web services computing environment, and the method is performed as an on-demand service.

21. A system comprising:
a server configured to
receive design information input by a designer,
receive an inquiry input by a customer,
present product information to the customer relating to the inquiry, the product representing an embodiment of the design,
iteratively modify the design in accordance with at least one of
additional information input by the designer and
product preferences input by the customer,
receive a product order from the customer, and
transmit instructions for delivery of the product to the customer.

22. A system according to claim 21, further comprising a device accessible by the customer for producing the product in accordance with the instructions from the server.

23. A system according to claim 21, further comprising a storage device for storing at least one of said design information and said additional information.

24. A system according to claim 21, wherein the server is connected to a network for communicating with the customer and the designer.

25. A system according to claim 24, wherein said design information is uploaded to the server via the network.

26. A system according to claim 21, wherein said product information includes a plurality of configurations of the product, so that a plurality of options are offered to the customer with regard to the product.

27. A system according to claim 21, wherein the server is configured to iteratively present the modified designs to the customer and/or to the designer, and wherein said presenting is performed via a website.

28. A system according to claim 21, wherein the server is configured to receive additional customer product preferences subsequent to said step of presenting product information.

29. A system according to claim 22, wherein said device is a printer configured to produce said product in accordance with instructions transmitted to the printer from the server.

30. A system according to claim 29, wherein said instructions cause the printer to print a design on paper or fabric.

31. A system according to claim 21, wherein said product is delivered as components for assembly at the customer's location.

32. A system according to claim 22, wherein the device produces components of the product for assembly at the customer's location.

33. A system according to claim 21, wherein the server is configured as part of a web services computing environment, and the product is designed and delivered as an on-demand service.

34. A method according to claim 1, wherein
said product comprises a modular carrying bag including a plurality of components,
said product preferences include a color and/or a shape of at least one component, and
said product is delivered in modular form for assembly by the customer.

35. A system according to claim 21, wherein
said product comprises a modular carrying bag including a plurality of components,
said product preferences include a color and/or a shape of at least one component, and
said product is delivered in modular form for assembly by the customer.

36. A method comprising:
receiving design information input by a designer;
receiving an inquiry input by a customer;
presenting product information to the customer relating to the inquiry, the product representing an embodiment of the design;
modifying the design in accordance with at least one of
additional information input by the designer and
product preferences input by the customer;
receiving a product order from the customer; and
causing said product to be delivered to the customer,
wherein said product includes a plurality of components assemblable by the customer, and said components are assemblable into a plurality of configurations, thereby permitting the customer to assemble a customized product.
